(19) United States
(12) Patent Application Publication
(10) Pub. No.: US 2026/0359751 A1
(43) Pub. Date: Nov. 12, 2026

(54) PLAN COORDINATION DEVICE, PLAN COORDINATION SYSTEM, AND PLAN COORDINATION METHOD

(71) Applicant: Hitachi, Ltd., Tokyo (JP)

(72) Inventors: Yuichi KOBAYASHI, Tokyo (JP); Takashi YANAGIDA, Tokyo (JP)

(21) Appl. No.: 19/153,684

(22) PCT Filed: Nov. 13, 2023
(86) PCT No.: PCT/JP2023/040750

§ 371 Date: Aug. 5, 2025

(30) Foreign Application Priority Data
Feb. 21, 2023 (JP) 2023-025051

(51) Int. Cl. G06Q 10/0631

(52) U.S. Cl. CPC G06Q 10/06316

(57) ABSTRACT

The plan coordination system includes: a first plan production unit that produces a first plan related to a first task on the basis of a first constraint condition; a second plan production unit that produces a second plan related to a second task on the basis of each of the first plan and a second constraint condition; a plan evaluation unit that evaluates the first plan and the second plan; and a constraint addition unit that changes the first constraint condition for the first plan production unit according to a result of the evaluation by the plan evaluation unit. The first plan production unit updates the first plan on the basis of the first constraint condition adjusted by the constraint addition unit.

### TECHNICAL FIELD

The present invention relates to a plan coordination device, a plan coordination system, and a plan coordination method that coordinate a plurality of plans.

### BACKGROUND ART

For example, in plant operation, it is desirable to develop and operate an integrated plan in which a plurality of plans from a plurality of perspectives are linked together so as to satisfy a predetermined level of criteria (KPI).

FIG. 1 illustrates an example of specific individual plans, in which a sales plan P1 is set as a most upstream plan, and an inventory replenishment plan P2, a production plan P3, a personnel plan P4, a process step plan P5, and a personnel operation instruction plan P6 are sequentially set. In addition, for each of the plans P, the predetermined level of criteria KPI (KP1, KPI2, . . . KP6) are set, and it is assumed that the criteria are met.

In such a planning process, it is desired to provide a device that generates a production plan through the planning process and performs production according to the generated plan. In addition, the planning process is divided into a plurality of divisions and, after adjustment between the plurality of divisions, the production plan is generated. For example, a sales plan, the production plan, or the like is generated by each of the divisions along the KPI specific to the division on the basis of a plan of another division.

Patent Literature 1 aims at providing, as a method for plan integration as described above, a value chain plan coordination method, a value chain plan coordination device, and a value chain plan coordination system each capable of calculating planning parameters that allow an optimum result to be obtained between a plurality of software items operating in coordination with each other, and proposes that “any of the plurality of software items uses output parameters obtained from another software item as input parameters. The value chain plan coordination device includes a different solution request unit that calculates the plurality of output parameters in each of the plurality of software items and a display control unit that calculates a best key performance indicator value in an entire value chain and causes a display unit to display the best key performance indicator value”.

### CITATION LIST

### Patent Literature

Patent Literature 1: Japanese Unexamined Patent Application Publication No. 2022-50057

### SUMMARY OF INVENTION

### Technical Problem

In a typical plan integration case example in FIG. 1, it is appropriate to optimize a plurality of plans connected to each other, such as upstream/downstream plans, not “individually”, but “in coordination”. However, when the downstream is to make a plan on the basis of the upstream plan, there is a problem that the downstream has fewer choices and needs to compromise, and consequently the downstream is less likely to be optimized as a company. In addition, when planning is to be performed through discussions among the different divisions, it is easy to optimize the planning, but there is a problem that discussion time is long and production cost is high.

In this respect, Patent Literature 1 has left a problem to be solved in that, since a plan is generated sequentially from the upstream and the downstream, the downstream has fewer choices and needs to compromise, overall optimization is hard to achieve, and it is difficult to convey a downstream request to the upstream.

In view of the foregoing, it is an object of the present invention to provide a plan coordination device, a plan coordination system, and a plan coordination method that can achieve overall optimization by generating a plan to optimize the KPI of each of the divisions in a balanced manner in a short time and coordinating the plans of the plurality of divisions.

### Solution to Problem

As described above, the present invention provides “a plan coordination system including: a first plan production unit that produces a first plan related to a first task on the basis of a first constraint condition; a second plan production unit that produces a second plan related to a second task on the basis of each of the first plan and a second constraint condition; a plan evaluation unit that evaluates the first plan and the second plan; and a constraint addition unit that changes the first constraint condition for the first plan production unit according to a result of the evaluation by the plan evaluation unit, and the first plan production unit updates the first plan on the basis of the first constraint condition adjusted by the constraint addition unit.”

Further, the present invention provides “a plan coordination device that receives, as an input thereto, each of a first plan related to a first task and produced on the basis of a first constraint condition and a second plan related to a second task and produced on the basis of each of the first plan and a second constraint condition, and includes: a plan evaluation unit that evaluates each of the first plan and the second plan; and a constraint addition unit that changes the first constraint condition according to a result of the evaluation by the plan evaluation unit, and the plan coordination device receives again, as the input thereto, each of the first plan determined on the basis of the changed first constraint condition and the second plan related to the second task and produced on the basis of each of the first plan after being changed and the second constraint condition.”

Furthermore, the present invention provides “a plan coordination method that includes: producing a first plan related to a first task on the basis of a first constraint condition; producing a second plan related to a second task on the basis of the first plan and a second constraint condition; evaluating the first plan and the second plan; changing the first constraint condition according to a result of the evaluation; updating the first plan on the basis of the changed first constraint condition; and determining the second plan again on the basis of the updated first plan and the second constraint condition.”

### Advantageous Effects of Invention

According to the present invention, it is possible to eliminate waste in production and implement overall optimized production.

### BRIEF DESCRIPTION OF DRAWINGS

FIG. 1 is a diagram illustrating an example of specific individual plans.

FIG. 2 is a diagram illustrating a schematic configuration example of a plan coordination system according to a first embodiment of the present invention.

FIG. 3 is a diagram conceptually illustrating processing in a learning unit 31A and an execution unit 31B of a plan coordination device 30.

FIG. 4 is a diagram illustrating case examples of inputs/outputs and processing details in a production plan and a personnel plan.

FIG. 5 is a diagram illustrating a process of making adjustment between the production plan and the personnel plan, while adding constraints.

FIG. 6 is a diagram illustrating a list of symbols to be used in various formulae or the like in the production plan and the personnel plan in FIG. 4.

FIG. 7 is a diagram additionally illustrating a concept in processing in each of the units in the first embodiment of the present invention.

FIG. 8 illustrates a flow showing details of processing in the learning unit 31A of the plan coordination device 30.

FIG. 9 illustrates a flow showing details of processing in the execution unit 31B of the plan coordination device 30.

FIG. 10 is a diagram illustrating an example of a preferred screen configuration to be displayed on a monitor serving as an output device 33 in FIG. 2.

### DESCRIPTION OF EMBODIMENTS

Referring to the drawings, a description will be given below of embodiments of the present invention. Each of the embodiments is an example for describing the present invention, and is omitted and simplified as appropriate for clarification of the description. The present invention can be implemented in various other modes. Unless otherwise particularly limited, constituent elements may be either singular or plural. In order to facilitate understanding of the invention, a position, size, shape, range, and the like of each of the constituent elements illustrated in the drawings may not represent an actual position, size, shape, range, and the like thereof. For this reason, the present invention is not necessarily limited to a position, size, shape, range, and the like disclosed in the drawings.

### First Embodiment

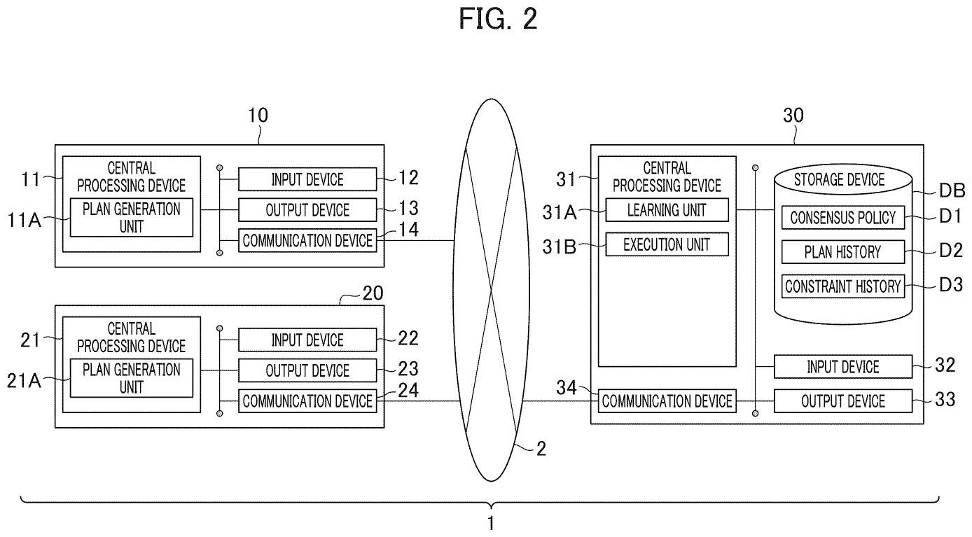

FIG. 2 is a diagram illustrating an example of a schematic configuration of a plan coordination system according to the first embodiment of the present invention. In a plan coordination system 1, a plurality of plan generation devices 10 and 20 and a plan coordination device 30 are connected via a communication network 2.

The plan generation devices 10 and 20 and the plan coordination device 30, each formed of a calculator device, are configured to include central processing devices 11, 21, and 31, input devices 12, 22, and 32, output devices 13, 23, and 33, and communication devices 14, 24, and 34. In a storage device DB of the plan coordination device 30, data D such as a consensus policy D1, a plan history D2, and a constraint history D3 is held.

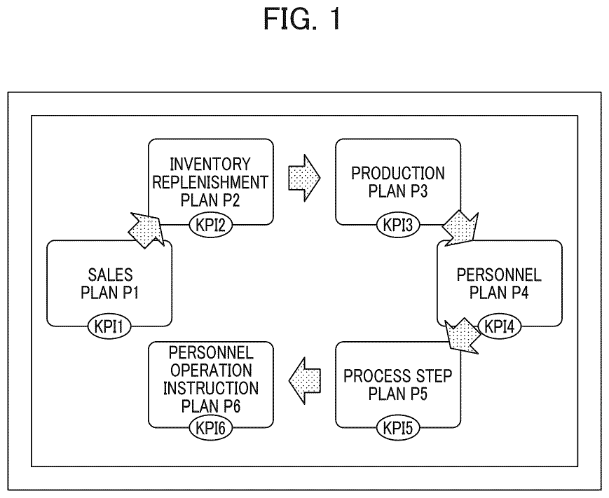

The plan generation device 10 is a device in an upper-side planning division, and a plan generation unit 11A generates, e.g., a sales plan P1 in an example of FIG. 1. Meanwhile, the plan generation device 20 is a device in a lower-side planning division adjacent to the upper-side planning division, and a plan generation unit 21A generates, e.g., an inventory replenishment plan P2 in the example in FIG. 1. Note that, to a specific plan generation method, an existing method is applicable and, in the present invention, any planning method can be used.

The plan coordination device 30 uses and coordinates two adjacent plans having an upstream-downstream relationship therebetween to obtain upstream/downstream revision plans. The plan coordination device 30 also locates the downstream revision plan thus obtained as the upstream plan in the subsequent stage, and further coordinates the upstream plan and the downstream plan (production plan P3 in the example in FIG. 1) to obtain further upstream/downstream revision plans. In the present invention, this is repetitively executed until the most downstream personnel operation instruction plan P6 is reached.

A learning unit 31A of the plan coordination device 30 is connected to the plurality of plan generation devices 10 and 20 to implement the plan generation units 11A and 21A, evaluate each of the plans, and generate the consensus policy D1. An execution unit 31B of the plan coordination device 30 refers to the consensus policy D1 to add a constraint to each of the plan generation units 11A and 21A and generate a plan. Note that details of processing in the learning unit 31A is basically the same as details of processing in the execution unit 31B.

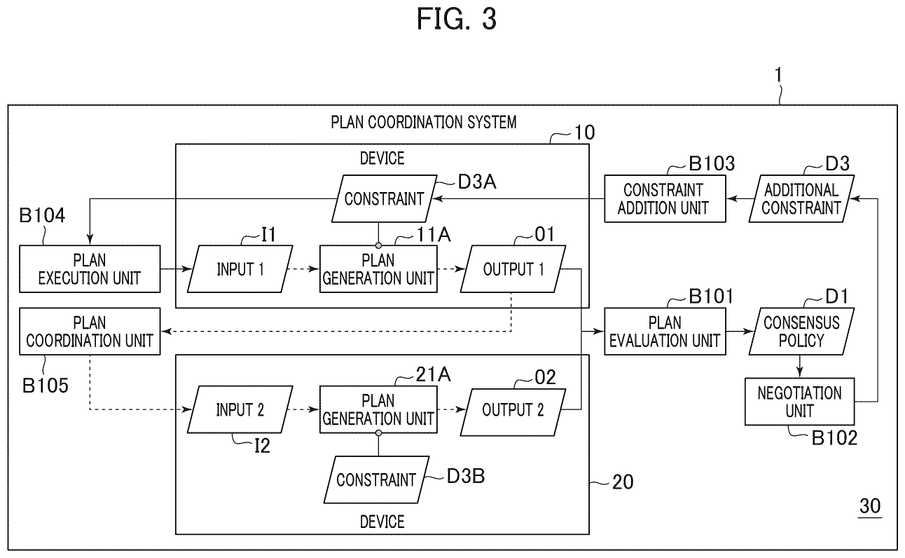

FIG. 3 is a diagram conceptually illustrating processing in the learning unit 31A and the execution unit 31B of the plan coordination device 30. In FIG. 3, B101 to B105 denote processing functions in the learning unit 31A and the execution unit 31B of the plan coordination device 30. Meanwhile, various information items (inputs I1 and 12, outputs O1 and O2, the consensus policy D1, and the constraint conditions D3, D3A, and D3B) to be used in this processing are indicated by rhomboids.

In the plan generation devices 10 and 20, the inner plan generation units 11A and an inner plan generation unit 11B add changes for complying with the constraint conditions D3A and D3B to the inputs I1 and 12 for the given plan and outputs the outputs O1 and O2 for the plan. For example, in a first stage of the plan, plans are made in the most upstream division and the downstream division adjacent thereto and, at this time, the plan generation unit 11A generates the sales plan P1 as the output O1, while the plan generation unit 11B generates the inventory replenishment plan P2 as the output O2. In the subsequent stage, for the generated replenishment plan P2 and the production plan P3 downstream thereof, the plan generation unit 11A and the plan generation unit 11B separately handle inputs and outputs thereof. Likewise, the plan generation unit 11A and the plan generation unit 11B successively handle inputs and outputs thereof for downstream processing.

Details of such combination processing repeatedly performed are basically the same, and therefore the following description will be given of the production plan P3 in a middle stage of the plan and the personnel plan P4 downstream thereof as specific case examples.

At this time, the plan generation unit 11A of the upstream plan generation device 10 that generates the production plan P3 adds changes for complying with the constraint condition D3A related to the production plan P3 to the input I1 related to the production plan P3 on the basis thereof to generate the output O1 related to the production plan P3. However, in an initial state of the processing in the plan generation unit 11A, as the input I1 related to the production plan P3, an output obtained as a result of the combination processing in the previous stage (the inventory replenishment plan P2 and the production plan P3) is used as the input I1 related to the production plan P3 in the plan generation unit 11A.

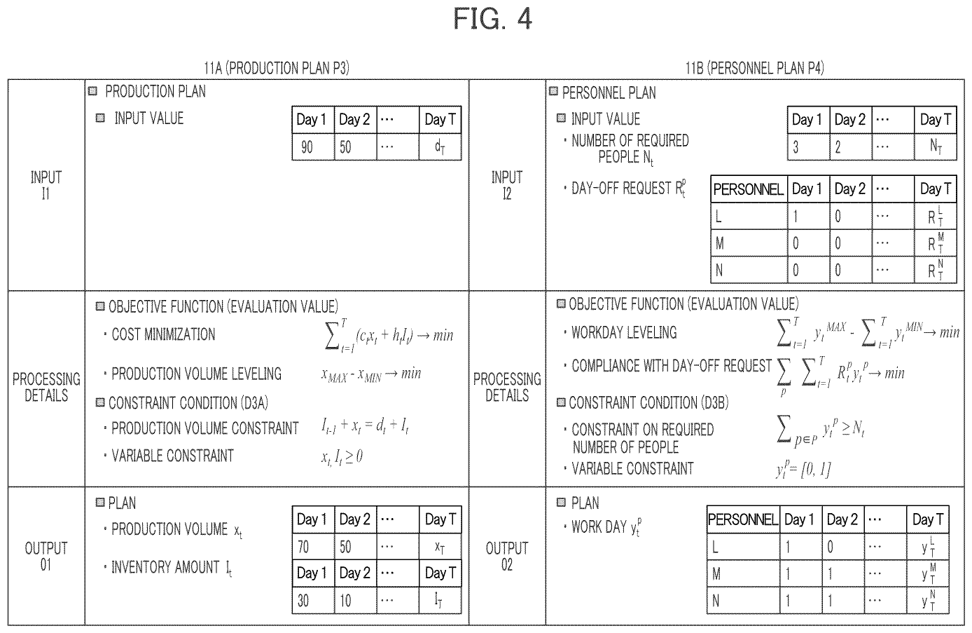

FIG. 4 is a diagram illustrating case examples of inputs/outputs and processing details in the production plan P3 and the personnel plan P4. On the left side, the input I1, the details of the processing, and the output O1 of the plan generation unit 11A that performs the production plan P3 are illustrated while, on the right side, the input 12, the processing details, and the output O2 of the plan generation unit 11B that performs the personnel plan P4 are illustrated. According to this, the input I1 of the plan generation unit 11A that performs the production plan P3 is a required per-day (Day 1, Day 2 . . . Day T) production volume, while the output O1 thereof is a per-day (Day 1, Day 2 . . . Day T) production volume xt, and may appropriately includes an inventory amount 1t.

Note that processing details in the production plan P3 are to determine the per-day/per-product production volume xt and, using a perspective of production cost minimization and production volume leveling as an objective function, produce the production plan P3 (the production volume xt and the inventory amount 1t) in the plan generation unit 11A under a production volume constraint as the constraint condition D3A. Thus, while rendering the constraint condition D3A variable, a condition that can maximize the production volume xt, while minimizing cost and leveling the production volume, is searched for.

Returning to FIG. 3, next, a plan coordination unit B104 converts the output O1 related to the production plan P3 to the input 12 related to the personnel plan, and uses the input 12 as an input to the plan generation unit 11B that generates the personnel plan P4. In response to this, the plan generation unit 11B of the downstream plan generation device 10 that generates the personnel plan P4 adds a change for complying with the constraint condition D3B related to the personnel plan P4 to the input 12 related to the personnel plan P4 on the basis thereof to generate the output O2 related to the personnel plan P4.

According to the input 12, the processing details, and the output O2 of the plan generation unit 11B that performs the personnel plan P4, the input 12 of the plan generation unit 11B that performs the personnel plan P4 is a number Nt of per-day (Day 1, Day 2 . . . Day T) required people and a day-off request R, while the output O1 thereof is a per-day (Day 1, Day 2 . . . Day T) work day y. It is to be noted herein that converting the output O1 related to the production plan P3 to the input 12 related to the personnel plan P4 means producing an upper right table in FIG. 4 from a lower left table therein.

Meanwhile, the processing details in the personnel plan P4 is to determine per-personnel (L, M, and N) work days and, using personnel workday leveling and minimization of violations of personnel day-off requests as an objective function, work days are produced in the plan generation unit 11B under the constraint of the number of required people as the constraint condition D3B. Thus, while rendering the constraint condition D3B variable, a condition that can optimize the work days is searched for.

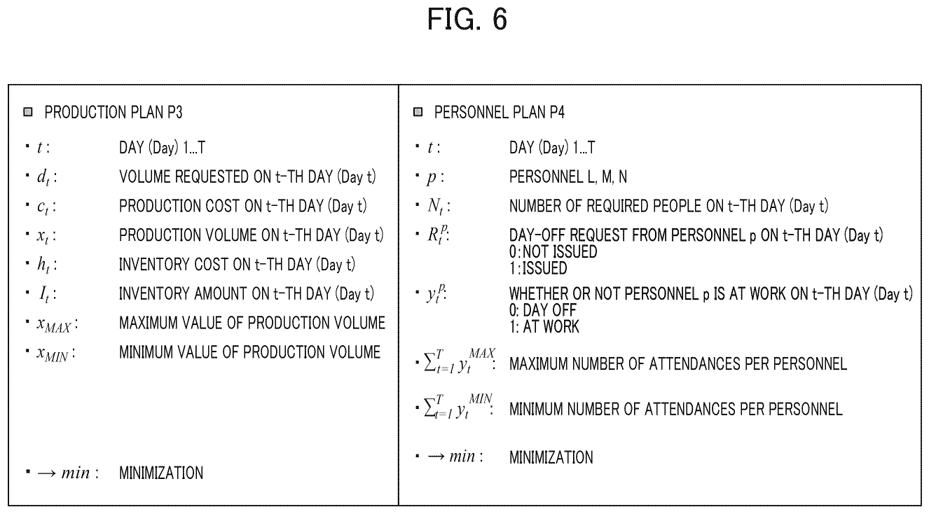

Note that a list of the symbols to be used in the various formulae or the like in the production plan P3 and the personnel plan P4 is illustrated in FIG. 6, but a detailed description thereof is omitted.

As a result of the processing described heretofore, in the case example in FIG. 4, the production plan P3 and the personnel plan P4 are compared and contrasted as two adjacent upstream and downstream plans among the plurality of plans in the plan evaluation unit D101 in FIG. 3.

In an initial state, this is a table of the production value in a lower left column in FIG. 4 and a table of the personnel plan (the number of required people and the day-off requests) in the upper right column in FIG. 4.

The plan evaluation unit B101 in FIG. 3 evaluates the output O1 (production plan P3) and the output O2 (personnel plan P4) and updates the consensus policy D1. Meanwhile, a negotiation unit B102 generates an additional constraint D3 to be added to the plan generation unit 10 so as to improve an evaluation of the output O2 (personnel plan P4). In a constraint addition unit B103, the constraint condition D3A in the plan generation unit 10 is changed, and then the processing in the plan generation device 10 is performed again. By repeating such a series of the processes, the consensus policy D1 is updated.

Note that the consensus policy D1 is, e.g., a function (correspondence table) of receiving the output O1 and the output O2 and outputting a priority of each of the constraints that can be added. In the consensus policy D1, when a plan on a given day is changed, as an improving effect due to the change is higher, the priority is set higher, and therefore it can be said that, by adopting an improvement plan with a higher priority, it is possible to reduce optimization acquisition time.

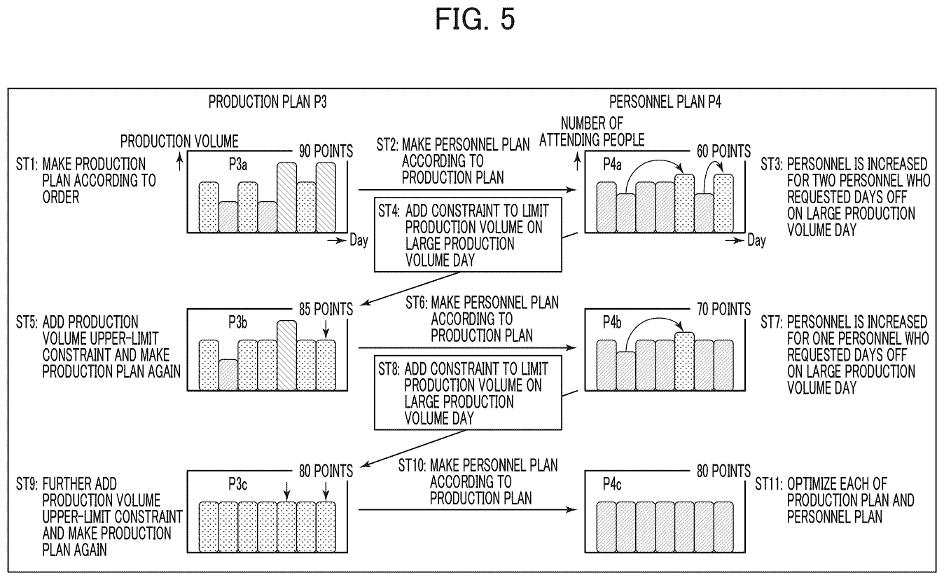

FIG. 5 is a diagram illustrating a process of making adjustment between the production plan P3 and the personnel plan P4, while adding a constraint. On the left side of the drawing, the production plan P3 is illustrated while, on the right side thereof, the personnel plan P4 is illustrated in a per-day graphic form. In an initial state in an upper row, the production plan in the lower left row in FIG. 4 and the personnel plan (the number of required people and the day-off requests) in the upper right row in FIG. 4 are respectively illustrated as initial states P3a and P4a in a tabular form.

When the production plan P3a and the personnel plan P4a in the initial state in FIG. 5 are compared to each other, a per-day correspondence relationship between the production plan P3a and the personnel plan P4a is not necessarily well balanced. Accordingly, in order to finally achieve a balanced per-day allocation as in a production plan P3c and a personnel plan P4c in FIG. 5, review of the plan is updated as the consensus policy D1.

The concept of this repeated processing will be described with reference to FIG. 5. In a first processing stage ST1, the plan execution unit B104 makes the production plan P3a according to an order (the input I1 for the production plan) and, in a processing stage ST2, the plan coordination unit B105 performs conversion to the personnel plan P4a according to the production plan P3a. In a processing stage ST3, the evaluation changing unit B101 obtains, e.g., a consensus policy such that “the personnel is increased for two personnel who requested days off on a large production volume day” according to a difference between the production plan P3a and the personnel plan P4a and, in a processing stage ST4, the negotiation unit B102 sets the additional constraint D3 such that “a constraint to limit the production volume on the large production volume day is added”, and the constraint addition unit B103 uses this constraint as a new constraint to be placed on the plan generation device 10.

In a subsequent processing stage ST5, the plan execution unit B104 adds a production volume upper-limit constraint to make a production plan P3b again and, in a processing stage ST6, the plan coordination unit B105 performs conversion to a personnel plan P4b according to the production plan P3b. In a processing stage ST7, the evaluation changing unit B101 obtains a consensus policy such that “the personnel is increased for one personnel who requested days off on a large production volume day” according to a difference between the production plan P3b and the personnel plan P4b and, in a processing stage ST8, the negotiation unit B102 sets the additional constraint D3 such that “a constraint to limit the production volume on the large production volume day is added”, and the constraint addition unit B103 uses this constraint as a new constraint to be placed on the plan generation device 10.

Moreover, in a subsequent processing stage ST9, the plan execution unit B104 further adds a production volume upper-limit constraint to make the production plan P3c again and, in a processing stage ST10, the plan coordination unit B105 performs the conversion to the personnel plan P4c according to the production plan P3c. In a processing stage ST11, the evaluation changing unit B101 determines that each of the production plan and the personnel plan has been optimized according to the difference between the production plan P3b and the personnel plan P4b, and ends the series of repeated processing.

In this drawing, when the production plan P3a is to be subjected to, e.g., KPI evaluation, it is assumed that the production plan P3a could be evaluated at 90 points. Meanwhile, when the personnel plan P4a is to be subjected to, e.g., the KPI evaluation, it is assumed that the personnel plan P4a could be evaluated at 60 points. It is assumed hereinbelow that P3B, P4b, P3c, and P4c were also evaluated at 85, 70, 80, and 80 points, respectively. In this case, a total evaluation of the production plan P3a and the personnel plan P4a is 150 points, a total evaluation of the production plan P3b and the personnel plan P4b is 155 points, and a total evaluation of the production plan P3c and the personnel plan P4c is 160 points, and it can be said that, as a result of learning carried out while changing the additional constraint D3, an overall highly evaluated coordination plan was produced.

Note that various information in the series of processing described above is cumulatively stored appropriately as setting information, intermediate product information, and end product information as the consensus policy D1, the plan history D2, and the constraint history D3 in the storage device DB in FIG. 2, and can be used appropriately for subsequent processing.

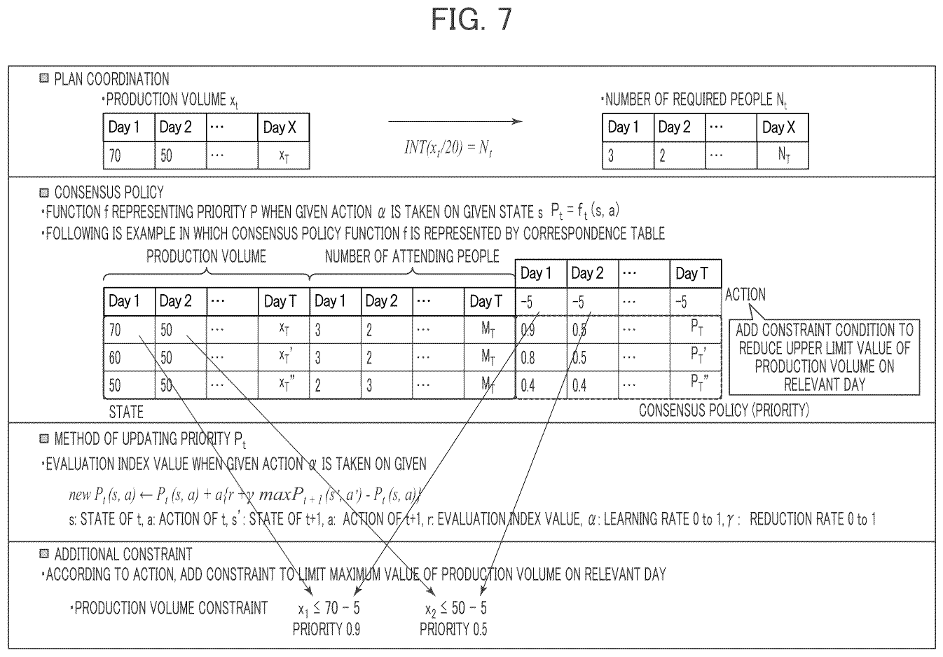

FIG. 7 additionally illustrates a concept in the processing in each of the units in the first embodiment of the present invention. First, in an upper row in FIG. 7, a method of converting the production volume xt to the number of required people can be obtained on the basis of Expression 1.

[Expression 1]

INT(xt/20)=Nt (1)

In a second row in FIG. 7, the consensus policy is a function f representing a priority p when a given action a is taken on a given state S, which can be obtained on the basis of Expression 2.

[Expression 2]

pₜ=fₜ(S,a) (2)

An example in which the consensus policy function f is represented by a correspondence table is shown herein. As shown in a frame, the consensus policy (priority) can be represented by numerical values in a correspondence between the per-day production volume and the number of attending people. In addition, as the action, a constraint condition that reduces an upper limit value of the production volume on the relevant day is added.

In a third row in FIG. 7, a method of updating a priority pt can be obtained using an evaluation index value when the action a is taken on the given state S on the basis of Expression 3, where S represents a state of t, a represents an action of t, S′ represents a state of t+1, a′ represents an action of t+1, r represents an evaluation index value, α represents a learning rate 0-1, and γ represents a reduction rate 0-1.

[Expression 3]

newPt(S,a)←Pt(S,a)+α{r+γ max Pt+1(S′,a′)−Pt(S,a)} (3)

In a fourth row in FIG. 7, the additional constraint D3 is to add a constraint to limit a maximum value of the production volume on the relevant day according to the action. The production volume constraint is to set, for day 1, a production volume x1 to a value equal to or less than a value obtained by subtracting 5 determined by the action from 70 and set, for day 2, a production volume x2 to a value equal to or less than a value obtained by subtracting 5 determined by the action from 50. Note that priorities for this action are left unchanged at “0.9” and “0.5”.

The description given above in the present invention has been performing optimization according to the concept of the consensus policy (priority). However, since there are various optimization methods in general, the present invention is not limited to this concept of the consensus policy (priority). In short, when there are any inconsistency between upstream and downstream two plans, it is sufficient to be able to equalize and optimize the two plans. By applying a well-known learning method, the optimization can be performed.

In short, the plan coordination system shown in the first embodiment includes the first plan production unit 10 that produces a first plan related to a first task on the basis of a first constraint condition, a second plan production unit 20 that produces a second plan related to a second task on the basis of each of the first plan and a second constraint condition, the plan evaluation unit B101 that evaluates the first plan and the second plan, and the constraint addition unit B103 that changes the first constraint condition for the first plan production unit 10 according to a result of the evaluation by the plan evaluation unit B101. The first plan production unit 10 updates the first plan on the basis of the first constraint condition adjusted by the constraint addition unit B103.

In addition, the plan coordination system includes a learning stage in which update processing for the first plan is performed a plurality of times and an execution stage in which the first plan and the second plan under the first constraint condition when an excellent evaluation result is obtained are obtained, the first constraint condition being selected from among the first constraint conditions when the update processing is performed the plurality of times.

### Second Embodiment

In the first embodiment, the description has been given mainly of a hardware configuration of the plan coordination system of the plan coordination system.

By contrast, in this embodiment, a description will be given of a plan coordination method.

Details of the processing in the plan coordination device described with reference to FIG. 2 or the like are described without distinguishing the learning stage and the execution stage from each other, but the learning unit 31A of the plan coordination device is connected to a plurality of plan generation devices to function to implement the plan generation unit, evaluate each of the plans, and generate the consensus policy, while the execution unit 31B of the plan coordination device functions to refer to the consensus policy, add a constraint to each of the plan generation units, and generate the plan.

These functions are for performing substantially the same processing, and a difference therebetween is whether the functions are performed to learn in advance and used to obtain a large number of consensus policies or whether the functions are applied to a real operational situation by using a result of obtaining the consensus policies.

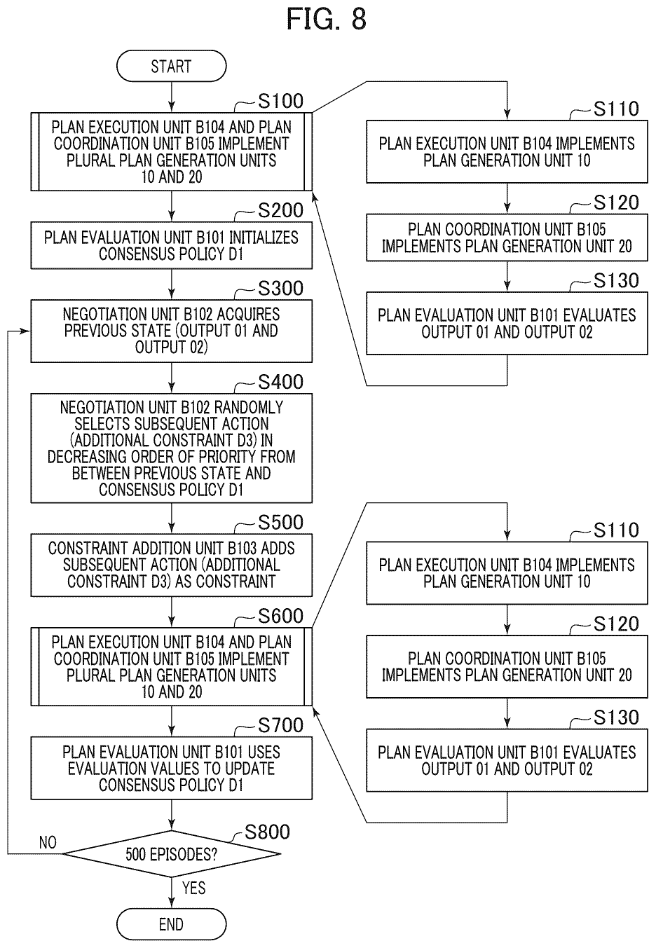

FIG. 8 is a flow illustrating details of processing in the learning unit 31A of the plan coordination device 30. In the processing, first, in a processing step S100, the plan execution unit B104 and the plan coordination unit B105 implement the plurality of plan generation units 10 and 20.

Specifically, in a processing step S110, the plan execution unit B104 implements the plan generation unit 10 to determine the production volume (inventory amount) as, e.g., an output of the production plan P3. In response to this, in a processing step S120, the plan coordination unit B104 implements the plan generation unit 20 to convert, e.g., the production volume as the output of the production plan P3 to the number of required people and the day-off request as the input 12 of the personnel plan P4, and then implements the plan generation unit 20 to determine the work days as an output of the personnel plan P4.

In a processing step S130, the plan evaluation unit B101 evaluates an output O1 and an output O2.

The evaluation made herein results from a comparison between the production plan p3a and the personnel plan P4a in FIG. 5 (or the lower left and the upper right in FIG. 4).

In this comparison result, an imbalance is observed, and therefore, in processing steps including and subsequent to S200, the repeated processing is performed until the production plan p3c and the personnel plan P4c in FIG. 5 are obtained. The number of times the repeated processing is to be performed is assumed to be 500 episodes described in a processing step S800 in the processing in the learning unit 31A in FIG. 8. In an initial state of the repetition, in the processing step S200, the plan evaluation unit B101 initializes the consensus policy.

Next, in the processing step S300, the negotiation unit B102 acquires a previous state (the output O1 and the output O2). In an initial stage of the repetition, the production plan p3a and the personnel plan P4a in FIG. 5 are acquired.

Next, in the processing step S400, the negotiation unit B102 randomly selects, from the previous state and consensus policy, a subsequent action (additional constraint) in decreasing order of priority. Note that, in the initial stage of the repetition, the consensus policy has been initialized (a priority order has not been determined), and accordingly it is appropriate to allow the consensus policy and the action to arbitrarily occur to take action. As the number of the repetitions increases, it becomes possible to acquire a plurality of relationships between the consensus policies and the actions, and the priority order is generated.

In the processing step S500, the constraint addition unit B103 adds the subsequent action (additional constraint D3) as the constraint and, in the processing step S600, the plan execution unit B104 and the plan coordination unit B105 implements the plurality of plan generation units 10 and 20 on the basis of the additional constraint. Details of processing in the processing step S600 is the same as details of the processing in the processing step S100. In the processing step S700, the plan evaluation unit B101 uses an evaluation value to update the consensus policy D1.

In the processing step S800, a series of the processing in the processing steps S300 to S700 is repeated 500 times, while the additional constraint is changed. By this repeated processing performed 500 times, the consensus policy D1 is acquired every time the action is changed.

The consensus policy D1 acquired every time the action is changed is stored in such a format as that in a second row in FIG. 7 in the storage unit DB, and this result of learning means that the action and the consensus policy D1, which are for optimizing the inconsistency between two plans having an upstream-downstream relationship therebetween, are stored as numerical value information representing the priorities.

According to the stored consensus policy D1, whatever the details and magnitude of the action effective for the optimization are, degrees of the effects thereof are recognized as numerical values, which include information highly effective for an improvement (accordingly having a higher priority) and information having a low improving effect. Note that, as the number of times learning is performed increases, the effective information is more likely to be acquired, but an appropriate number of times is assumed to be, e.g., 500.

### Third Embodiment

In the second embodiment, the description has been given of generating the plurality of consensus policies by performing processing in the learning unit 31A of the plan coordination device a large number of times. In the learning stage in the second embodiment, by performing the learning the large number of times within a reasonable range, a large amount of the effective information is acquired and, in the execution stage, processing based on the effective information obtained by the learning is performed.

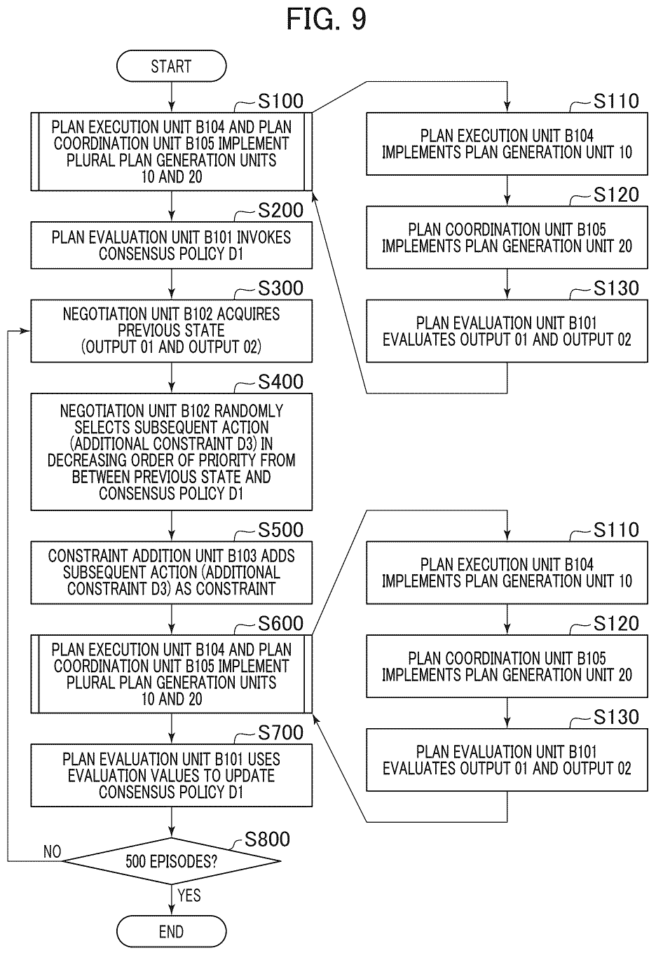

FIG. 9 is a flow illustrating details of the processing in the execution unit 31B of the plan coordination device 30. FIG. 9 is different from FIG. 8 in the processing step S200 and the processing step S800. In the processing step S200, the consensus policies D1 stored in the learning stage are used. In addition, the number of the consensus policies D1 in this case is a limited number (5 in this example) determined by the number of the episodes in the processing step S800 and, among the consensus policies D1 obtained in the 500 episodes in the learning, information selected according to the priority is used.

Thus, in the execution stage in the third embodiment, by the execution process performed a smaller number of times using the information highly effective for an improvement (accordingly having a higher priority), an optimum result can promptly be acquired.

According to the method of the present invention according to the second embodiment and the third embodiment, a first plan related to a first task is produced on the basis of a first constraint condition, a second plan related to a second task is produced on the basis of the first plan and a second constraint condition, the first plan and the second plan are evaluated, the first constraint condition is changed according to a result of the evaluation, the first plan is updated on the basis of the changed first constraint condition, and the second plan is determined again on the basis of the updated first plan and the second constraint condition.

The method of the present invention also includes a learning stage in which update processing for the first plan is performed a plurality of times and an execution stage in which the first plan and the second plan under the first constraint condition when an excellent evaluation result is obtained are obtained, the first constraint condition being selected from among the first constraint conditions when the update processing is performed the plurality of times.

In addition, for the second plan obtained after the first plan is updated and processing of determining the second plan again is performed a plurality of times, the second plan related to the second task is produced on the basis of the second constraint condition, a third plan related to a third task is produced on the basis of the second plan and a third constraint condition, the second plan and the third plan are evaluated, the second constraint condition is changed according to a result of the evaluation, the second plan is updated on the basis of the changed second constraint condition, and the third plan is determined again on the basis of the updated second plan and the third constraint condition.

### Fourth Embodiment

In the fourth embodiment, a description will be given of visualizing and presenting a result of determination processing by the plan coordination system 1.

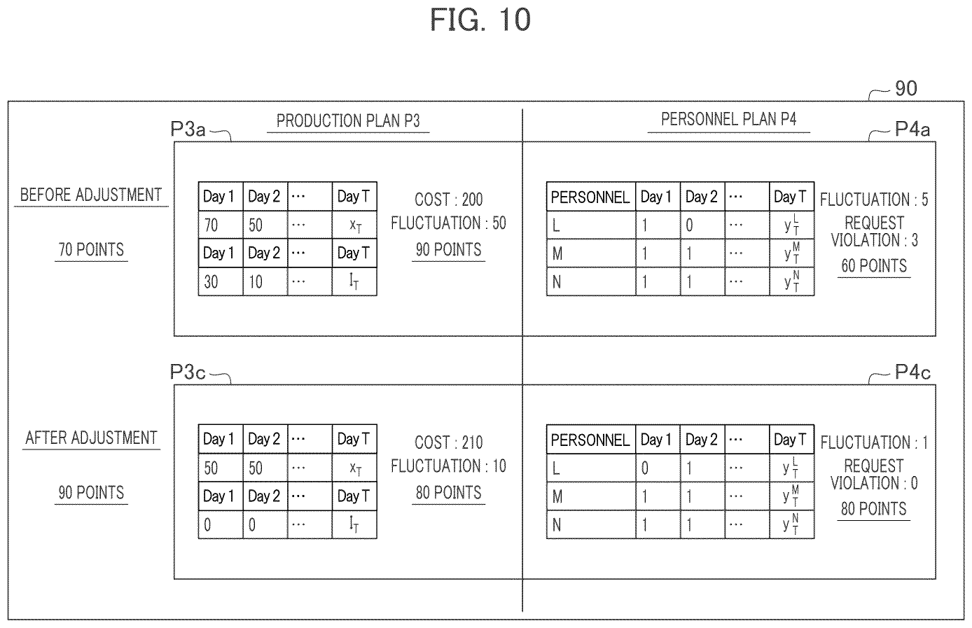

FIG. 10 illustrates an example of a screen configuration to be preferably displayed on a monitor serving as the output device 33 in FIG. 2. On a screen 90, for upstream and downstream plans, a state before adjustment and a state after the adjustment are numerically displayed, and it is appropriate that, by displaying KPI numerical values in conjunction with cost, fluctuations, the number request violations, and the like, a degree of improvement is visualized to be recognizable.

### Fifth Embodiment

In the fifth embodiment, a description will be given of several ways of thinking when the plan evaluation unit B101 evaluates the upstream first plan (production plan p3) and the downstream adjacent second plan (personnel plan P4).

In the first evaluation method, it may be appropriate that the plan evaluation unit B101 obtains first evaluation information, which is information related to the evaluation of the first plan, on the basis of information on the first plan and obtains second evaluation information, which is information related to the evaluation of the second plan, on the basis of information on the second plan and that the constraint addition unit B103 adjusts the first constraint condition such that a combination of the first evaluation information and the second evaluation information satisfies a predetermined condition.

In the second evaluation method, it may be appropriate that the constraint addition unit B103 further adjusts the second constraint condition such that the combination of the first evaluation information and the second evaluation information satisfies the predetermined condition and that the second plan production unit 20 updates the second plan on the basis of the second constraint condition adjusted by the constraint addition unit B103.

In the third evaluation method, it may be appropriate that each of the first evaluation information and the second evaluation information is information on a value indicating high-rate evaluation in a related task and that the constraint addition unit B103 adjusts the first constraint condition on the basis of a total of and a difference between a value of the first evaluation information and a value of the second evaluation information.

In the fourth evaluation method, it may be appropriate that the constraint addition unit B103 calculates a value of the first evaluation information and a value of the second evaluation information which individually correspond to a plurality of candidates for the first constraint condition after the adjustment, specifies, among the plurality of candidates for the first constraint condition after the adjustment, a first group of the candidates having a total of the value of the corresponding first evaluation information and the value of the corresponding second evaluation information which is larger than a predetermined threshold, and specifies, as the first constraint condition to be adopted, the candidate included in the first group of candidates and having a smallest difference between the value of the corresponding first evaluation information and the value of the corresponding second evaluation information.

In the fifth evaluation method, it may be appropriate that a storage unit that stores a consensus policy resulting from learning of a relationship between an amount of the adjustment of the first constraint condition and an amount of changing of the second evaluation information is included and that the constraint addition unit B103 adjusts the first constraint condition on the basis of the consensus policy.

In the sixth evaluation method, it may be appropriate that a storage unit DB that stores a consensus policy resulting from learning of a relationship between an amount of the adjustment of the first constraint and an amount of adjustment of the second constraint and an amount of the changing of the first evaluation information and an amount of changing of the second evaluation information is included and that the constraint addition unit B103 adjusts the first constraint condition and the second constraint condition on the basis of the consensus policy.

In the seventh evaluation method, it may be appropriate that a storage unit DB that stores a consensus policy to output an index of a priority of a first adjustment operation when at least information related to an amount of adjustment in the first adjustment operation of adjusting the first constraint condition, information on the second plan, and the second evaluation information are received as input information is included and that the constraint addition unit B103 adjusts the first constraint condition on the basis of the consensus policy.

### LIST OF REFERENCE SIGNS

| | |
|---|---|
| 2: | communication network |
| 10, 20: | plan generation device |
| 11, 21, 31: | central processing device |
| 12, 22, 32: | input device |
| 13, 23, 33: | output device |
| 14, 24, 34: | communication device |
| 11A, 21A: | plan generation unit |
| 30: | plan coordination device |
| 31A: | learning unit |
| 31B: | execution unit |
| B101: | plan evaluation unit |
| B102: | negotiation unit |
| B103: | constraint addition unit |
| B104: | plan execution unit |
| B105: | plan coordination unit |
| DB: | storage device |
| D1: | consensus policy |
| D2: | plan history |
| D3: | constraint history |

1. A plan coordination system comprising:
a first plan production unit that produces a first plan related to a first task on the basis of a first constraint condition;
a second plan production unit that produces a second plan related to a second task on the basis of each of the first plan and a second constraint condition;
a plan evaluation unit that evaluates the first plan and the second plan; and
a constraint addition unit that changes the first constraint condition for the first plan production unit according to a result of the evaluation by the plan evaluation unit,
wherein the first plan production unit updates the first plan on the basis of the first constraint condition adjusted by the constraint addition unit.

2. The plan coordination system according to claim 1, including: a learning stage in which update processing for the first plan is performed a plurality of times; and an execution stage in which the first plan and the second plan under the first constraint condition when an excellent evaluation result is obtained are obtained, the first constraint condition being selected from among the first constraint conditions when the update processing is performed the plurality of times.

3. The plan coordination system according to claim 1,
wherein the plan evaluation unit obtains first evaluation information, which is information related to the evaluation of the first plan, on the basis of information on the first plan, and obtains second evaluation information, which is information related to the evaluation of the second plan, on the basis of information on the second plan, and
wherein the constraint addition unit adjusts the first constraint condition such that a combination of the first evaluation information and the second evaluation information satisfies a predetermined condition.

4. The plan coordination system according to claim 3,
wherein the constraint addition unit further adjusts the second constraint condition such that the combination of the first evaluation information and the second evaluation information satisfies the predetermined condition, and
wherein the second plan production unit updates the second plan on the basis of the second constraint condition adjusted by the constraint addition unit.

5. The plan coordination system according to claim 3,
wherein each of the first evaluation information and the second evaluation information is information on a value indicating high-rate evaluation in a related task, and
wherein the constraint addition unit adjusts the first constraint condition on the basis of a total of and a difference between a value of the first evaluation information and a value of the second evaluation information.

6. The plan coordination system according to claim 3,
wherein the constraint addition unit calculates a value of the first evaluation information and a value of the second evaluation information which individually correspond to a plurality of candidates for the first constraint condition after the adjustment, specifies, among the plurality of candidates for the first constraint condition after the adjustment, a first group of the candidates having a total of the value of the corresponding first evaluation information and the value of the corresponding second evaluation information which is larger than a predetermined threshold, and specifies, as the first constraint condition to be adopted, the candidate included in the first group of candidates and having a smallest difference between the value of the corresponding first evaluation information and the value of the corresponding second evaluation information.

7. The plan coordination system according to claim 3, further comprising:
a storage unit that stores a consensus policy resulting from learning of a relationship between an amount of the adjustment of the first constraint condition and an amount of changing of the second evaluation information,
wherein the constraint addition unit adjusts the first constraint condition on the basis of the consensus policy.

8. The plan coordination system according to claim 3, further comprising:
a storage unit that stores a consensus policy resulting from learning of a relationship between an amount of the adjustment of the first constraint and an amount of adjustment of the second constraint and an amount of the changing of the first evaluation information and an amount of changing of the second evaluation information,
wherein the constraint addition unit adjusts the first constraint condition and the second constraint condition on the basis of the consensus policy.

9. The plan coordination system according to claim 3, further comprising:
a storage unit that stores a consensus policy to output an index of a priority of a first adjustment operation when at least information related to an amount of adjustment in the first adjustment operation of adjusting the first constraint condition, information on the second plan, and the second evaluation information are received as input information,
wherein the constraint addition unit adjusts the first constraint condition on the basis of the consensus policy.

10. A plan coordination device that receives, as an input thereto, each of a first plan related to a first task and produced on the basis of a first constraint condition and a second plan related to a second task and produced on the basis of each of the first plan and a second constraint condition, the plan coordination device comprising:
a plan evaluation unit that evaluates each of the first plan and the second plan; and
a constraint addition unit that changes the first constraint condition according to a result of the evaluation by the plan evaluation unit,
wherein the plan coordination device receives again, as the input thereto, each of the first plan determined on the basis of the changed first constraint condition and the second plan related to the second task and produced on the basis of each of the first plan after being changed and the second constraint condition.

11. A plan coordination method comprising:
producing a first plan related to a first task on the basis of a first constraint condition;
producing a second plan related to a second task on the basis of the first plan and a second constraint condition;
evaluating the first plan and the second plan;
changing the first constraint condition according to a result of the evaluation;
updating the first plan on the basis of the changed first constraint condition; and
determining the second plan again on the basis of the updated first plan and the second constraint condition.

12. The plan coordination method according to claim 11, including: a learning stage in which update processing for the first plan is performed a plurality of times; and an execution stage in which the first plan and the second plan under the first constraint condition when an excellent evaluation result is obtained are obtained, the first constraint condition being selected from among the first constraint conditions when the update processing is performed the plurality of times.

13. The plan coordination method according to claim 11, further comprising,
for the second plan obtained after the first plan is updated and processing of determining the second plan again is performed a plurality of times,
producing the second plan related to the second task on the basis of the second constraint condition;
producing a third plan related to a third task on the basis of the second plan and a third constraint condition;
evaluating the second plan and the third plan;
changing the second constraint condition according to a result of the evaluation;
updating the second plan on the basis of the changed second constraint condition; and
determining the third plan again on the basis of the updated second plan and the third constraint condition.
